(19) United States
(12) Patent Application Publication
(10) Pub. No.: US 2007/0275661 A1
(43) Pub. Date: Nov. 29, 2007

(54) Terminal device, communication system, and method for activating terminal device

(75) Inventor: Toru Homma, Kawasaki-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/802,013

(22) Filed: May 18, 2007

(30) Foreign Application Priority Data
May 19, 2006 (JP) P2006-140776

(51) Int. Cl. H04B 7/185

(52) U.S. Cl. 455/13.4

(57) ABSTRACT

According to one embodiment, there is provided a terminal device including: a wireless communication unit that communicates with a base station through a first communication channel; a network controller that communicates with a computer via the base station through a second communication channel; and a power controller that starts a power supply to the network controller in response to a call signal received by the wireless communication unit from the base station through the first communication channel.

### CROSS-REFERENCE TO RELATED APPLICATIONS

This application is based upon and claims the benefit of priority from Japanese Patent Application No. 2006-140776, filed May 19, 2006, the entire contents of which are incorporated herein by reference.

### BACKGROUND

1. Field

One embodiment of the present invention relates to a terminal device that is remotely activated, a communication system, and a method for activating the terminal device.

2. Description of the Related Art

As terminal devices such as a personal computer and PDA (Personal Digital Assistant) are getting smaller, terminal devices capable of communication even outside have been used. Such a terminal device is required to minimize the power consumption. Then, for example, the terminal device shuts down a driving mechanism such as a hard disk unit or dims its display lighting. In particular, a so-called sleep mode that automatically shuts down the main power source when the user does not operate the terminal device for a certain period greatly contributes to reduction in the power consumption of the terminal device.

In the sleep mode, the only minimum power necessary for storing the operating state before the power is shot down is supplied to the terminal device. The terminal device in the sleep mode cannot receive information from outside. Japanese Patent Application Publication (KOKAI) No. 2005-18377 discloses a system that automatically activates a terminal device through a wireless communication. In the system, an RF module receives a broadcast frame and so on.

In the system, the automatic activation is provided at a higher layer than the network layer in the OSI reference model so that a lot of features have to be implemented in a RF module. It is necessary to supply power to the wireless module even in the sleep mode in order to provide the automatic activation. An increase in the number of features implemented in the wireless module results in greater power consumption. For example, when a security approach such as VPN is introduced in order for the wireless module to securely transmit TCP/IP packets, it is necessary to implement a security feature in the wireless module. It is not easy to store codes to provide such sophisticated features and other features in a limited storage capacity of the wireless module. This causes to increased development costs.

In this way, the related art terminal device, communication system and method for activating a terminal device impose an enormous load of implementation of features on a wireless module and an increase in the power consumption.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary conceptual drawing showing a configuration of a communication system according to an embodiment of the invention;

FIG. 2 is an exemplary sequence diagram showing the operation of the communication system according to the embodiment;

FIG. 3 is an exemplary block diagram showing a configuration of the communication system according to the embodiment;

FIG. 4 is an exemplary flowchart showing the operation of a host server according to the embodiment;

FIG. 5 is an exemplary flowchart showing the operation of a base station according to the embodiment; and

FIG. 6 is an exemplary flowchart showing the operation of a terminal device according to the embodiment.

### DETAILED DESCRIPTION

Various embodiments according to the invention will be described hereinafter with reference to the accompanying drawings. In general, according to one embodiment of the invention, there is provided a terminal device including: a wireless communication unit that communicates with a base station through a first communication channel; a network controller that communicates with a computer via the base station through a second communication channel; and a power controller that starts a power supply to the network controller in response to a call signal received by the wireless communication unit from the base station through the first communication channel.

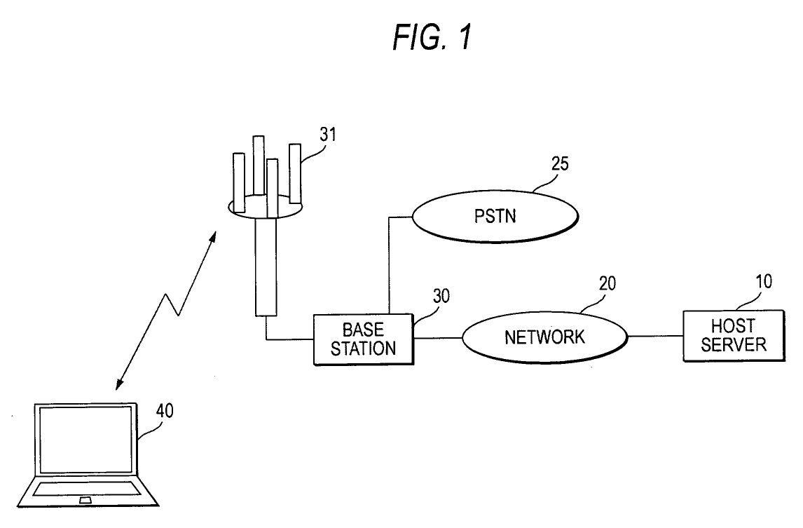

FIG. 1 is an exemplary conceptual drawing showing a configuration of a communication system according to an embodiment of the invention. As shown in FIG. 1, a communication system 1 according to the embodiment includes: a host server 10 connected to a network 20; a wireless base station 30 connected to the network 20 and including an antenna 31; and a terminal device 40 that wirelessly communicates with the base station 30.

The host server 10 stores and manages information such as mails or application data. The host server 10 is implemented by a computer and provides (transmit) information requested through the network 20 to the source of the request through the network 20. The host server 10 may install a server application such as a mail server, a database server and an http server.

The network 20 is a network such as the Internet connected to a plurality of server computers or client computers. The network 20 is implemented by a network that provides point-to-point communication by using a protocol such as TCP/IP.

The base station 30 is configured to be wirelessly connectable to a plurality of slave stations and that interconnects between the slave stations and the network 20 or a Public Switched Telephone Network (PSTN) 25. The base station 30 has a switching feature to switch lines between slave stations, the host server 10 connected to the network 20 and a telephone (not shown) connected to the PSTN 25. The base station 30 may use a 3G system such as a CDMA wireless communication system.

The terminal device 40 as a slave station is configured to be wirelessly connectable to the base station 30 as a master station. The terminal device may be a personal computer or the like. The terminal device 40 includes a wireless module that wirelessly communicates with the base station 30 and has an application for transmitting/receiving information such as a mail or a web browser installed in a storage.

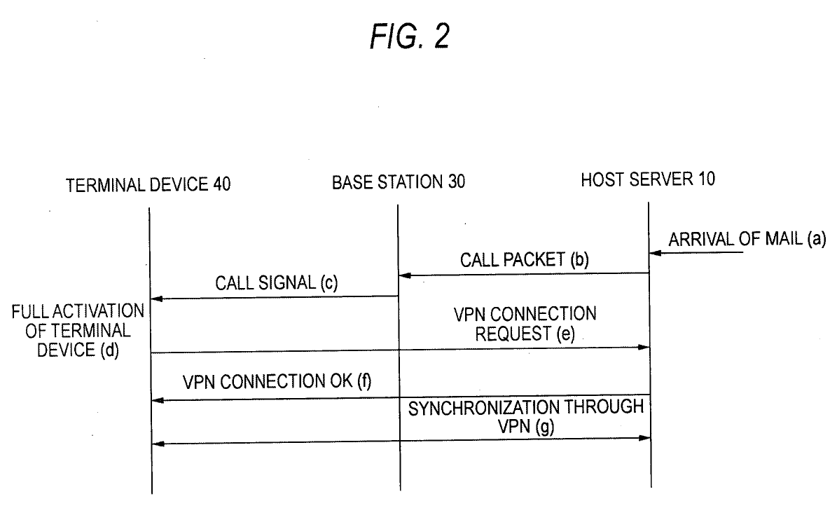

Operation of the wireless system 1 according to the embodiment will be described referring to FIG. 2. FIG. 2 is an exemplary sequence diagram showing the operation of the radio system 1 according to the embodiment. Referring to FIG. 2, a case will be described where a mail server is implemented in the host server 10 and the terminal device 40 accesses the mail server to synchronize mail.

Receiving a mail through the network 20 ((a) in FIG. 2), the host server 10 stores mails and determines whether a notice to the terminal device 40 is necessary from the mail header. When a notice is determined to be necessary, the host server 10 transmits a call packet (call frame) to the base station 30 through the network 20 (b). A call packet includes the identification number of the terminal device 40.

Receiving a call packet, the base station 30 determines whether the terminal device 40 as a slave station exists or not in the coverage of the base station 30. When the base station 30 determines that the terminal device 40 exists, the base station 30 transmits a call signal to the slave station (c). For a CDMA system, for example, the call signal may be a control signal specific to a wireless channel such as a common pilot signal or a call signal for the PSTN line. When the terminal device 40 does not exist in its coverage, the base station 30 may return an error message to the host server 10 or re-attempt calling after a predetermined period has elapsed.

Power is supplied to the wireless module of the terminal device 40 even in a so-called sleep mode and thus wireless connection with the base station 30 is maintained. Receiving a call signal to the terminal device 40, the terminal device 40 turns on the main power source to start a full activation process (d). The full activation refers to an operation of turning on the main power source so as to cause the terminal device 40 to return from the sleep mode and enable all of function thereof to activate. When the full activation is complete, the terminal device 40 starts to activate an initial application. The initial application may be a network configuration application or a VPN (virtual private network) application to provide security, or an application such as mail software.

When the VPN application is activated as an initial application, the terminal device 40 transmits a VPN connection request to the host server 10 through the base station 30 and the network 20 (e). Receiving a VPN connection request, the host server 10 returns connection permission and an encryption key to the terminal device 40 (f).

When a VPN connection is established, the terminal device 40 synchronizes various types of information through a VPN-connected channel (g). In this example, synchronization processing of reading new mails stored in the host server 10 into the terminal device 40 is performed.

In this way, in the communication system according to the embodiment, when a mail arrives at a host server, a call packet such as a packet at the network layer or a higher level is transmitted to a base station. In response to the call packet, the base station uses a call signal at the physical layer level to call up a terminal device. The terminal device is able to be automatically activated in response to the call signal as long as the feature at the physical layer level (a first protocol serving as a first communication channel) is activated. This contributes to reduction of standby power at the sleep mode. Further, an automatic activation control is made using a control signal specific to a wireless channel, which reduces the implementation load on a wireless channel.

After the automatic activation, a typical application activation sequence may be used. For example, by using the VPN feature, it is possible to provide secure synchronization of communication and information. In other words, it is possible to use the encrypting approach by way of a typical feature at the network layer level or higher (a second protocol serving as a second communication channel) without providing an arrangement for a communication channel encryption in a radio module, which facilitates system implementation.

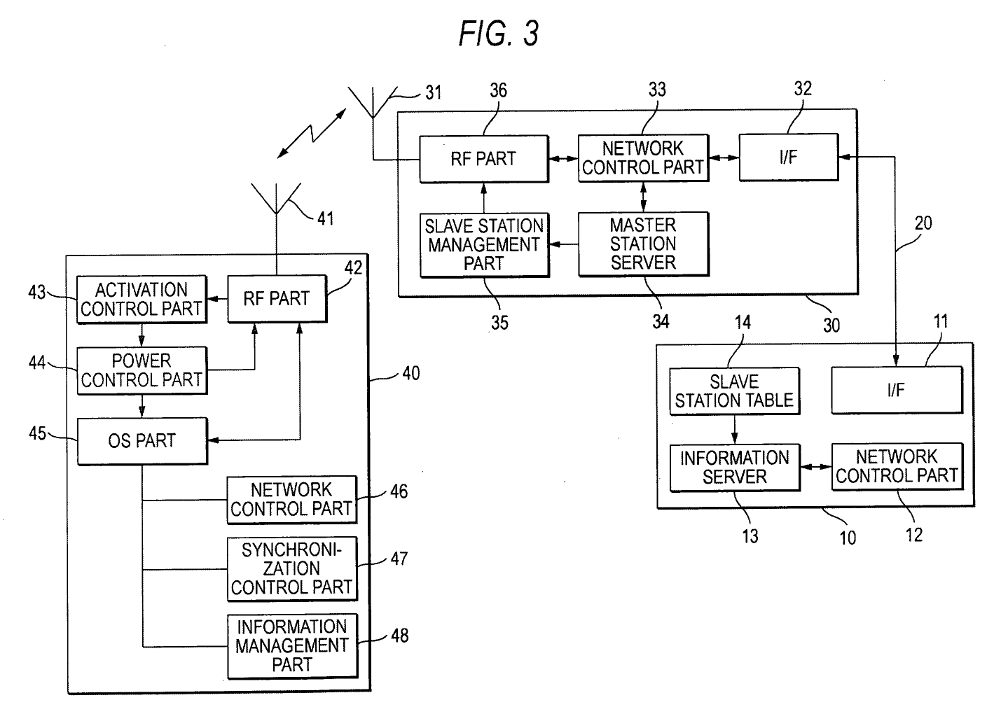

Next, referring to FIG. 3, a configuration of the host server 10, base station 30 and terminal device 40 in the communication system 1 according to the embodiment will be described in detail. FIG. 3 is a block diagram showing a configuration of the communication system according to the embodiment.

As shown in FIG. 3, the host server 10 according to the embodiment includes an I/F part 11, a network control part 12, an information server 13, and a slave station table 14.

The I/F part 11 is an interface for connecting the network 20 and is for example an interface unit for connecting the Ethernet®. The network control part 12 is a control unit for controlling communications through the network 20 and is for example a router or a gateway server. The network control part 12 controls a communication channel and has also a VPN connection feature to encrypt a communication channel.

The information server 13 includes a server group including a mail server and an http server that stores information accessed and shared by the terminal device 40. The information server 13, on receiving information (such as a mail) coming from outside through the I/F part 11 and the network control part 12, stores the information and transmit a call packet to the terminal device 40. The slave station table 14 is a storage for storing what is to be wirelessly connected through the base station 30 among the terminal devices accessing the information server 13, that is, a slave station.

The base station 30 according to the embodiment of the invention includes an antenna 31, an I/F part 32, a network control part 33, a master station server 34, a slave station management part 35 and an RF part 36.

The antenna 31 is an antenna for transmitting/receiving a radio wave for a wireless channel established by the base station 30. The I/F part 32 is an interface that corresponds to the I/F part 11 of the host server 10 and that is used to connect the network 20. The network control part 33 is a network card corresponding to the network control part 12 of the host server 10. The network control part 33 also switches calls on a wireless channel, the network 20, and the PSTN line 25 (not shown in FIG. 3).

The master station server 34 is a server that manages a slave station such as the terminal device 40 in the coverage of the base station 30. The master station server 34 calls up a slave station that has been accepted from the network 20 or PSTN line 25 and manages call origination or transmission to the network 20 or PSTN line 25. The slave station management part 35 is a control unit for managing a slave station in the coverage of the base station 30 and calling a slave station or performing a handover. The RF part 36 is a wireless communication unit for performing wireless communication with the terminal device 40 as a slave station through the antenna 31. As the RF part 36, a 3G system such as a CDMA wireless system may be used. The RF part 36 communicates with a plurality of slave stations at the same time.

The terminal device 40 according to the embodiment includes an antenna 41, an RF part 42, an activation control part 43, a power control part 44, an OS part 45, a network control part 46, a synchronization control part 47 and an information management part 48.

The antenna 41 is an antenna that corresponds to the antenna 31 of the base station 30 and that is used by the terminal device 40 to communicate with the base station 30. The antenna 41 may be incorporated in the terminal device 40 or externally provided. The RF part 42 is a wireless communication unit (wireless module) for performing wireless communication with the base station 30 as a master station through the antenna 41 and uses a system supported by the RF part 36 of the base station 30. Power is constantly supplied to the RF part 42 to keep the connection to the base station 30 irrespective of the ON/OFF of the main power of the terminal device 40. That is, the RF part 42 is constantly transmitting/receiving a control signal necessary for a master station to manage a slave station (or for a slave station to manage a master station) for example as to whether the terminal device 40 exists in the coverage of the base station 30, to/from the RF part 36 of the base station 30. Receiving a call signal to the RF part 42 from the RF part 36 of the base station 30, the RF part 42 passes the call signal to the activation control part 43.

The activation control part 43 fully activates the terminal device 40 based on the call signal passed from the RF part 42. Same as the RF part 42, power is constantly supplied to the activation control part 43. The activation control part 43 is configured to instruct the power control part 44 to supply the main power of the terminal device 40 when the terminal device 40 receives the call signal.

The power control part 44 is a power management unit for managing the main power of the terminal device 40. The power control part 44 supplies predetermined power to each part of the terminal device 40. The power control part 44 constantly supplies power to the RF part 42 and the activation control part 43 and turns on the main power of the terminal device 40 based on an instruction from the activation control part 43.

The OS part 45 is an operating system for controlling the entire operation of the terminal device 40. The terminal device 40 manages units or applications that provide all features of the terminal device 40 except the communication feature and power management feature of the RF part 42, activation control part 43 and power control part 44. The OS part 45 may be implemented by an operating system such as Windows® and UNIX®. The OS part 45 is activated when the power control part 44 turns on the main power source. And the OS part 45 enters the sleep mode where it stores the latest process details into a storage (or terminates all processes) when the main power source is turned off. In the sleep mode, all features of the terminal device 40 running on the OS part 45 stop operation.

A network control part 46 corresponds to the network control part 12 of the host server 10 and controls a communication channel through the network 20 and has a VPN connection feature to encrypt the communication channel. The network control part 46 is under control of the OS part 45 and does not control the network in a state such as the sleep mode where only the RF part 42, activation control part 43 and power control part 44 are active. In other words, in order for the terminal device 40 to communicate with the host server 10, the OS part 45 and the network control part 46 have to be active. While the network control part 46 is implemented for example by a TCP/IP stack operating on the OS, the network control part 46 may be implemented as part of the features of the OS part 45.

A synchronization control part 47 is an information processor for reading/writing information stored in the information server 13 in the host server 10 to synchronize the information. The synchronization control part 47 reads a mail stored in the information server 13 into the terminal device 40 or updates a predetermined file to keep the file in the latest state.

An information management part 48 is information processor for storing and managing information in the terminal device 40. For example, the information management part 48 is implemented by mail software, a web browser, or personal information management software and provides information from the terminal device 40 to the user through a display (not shown)

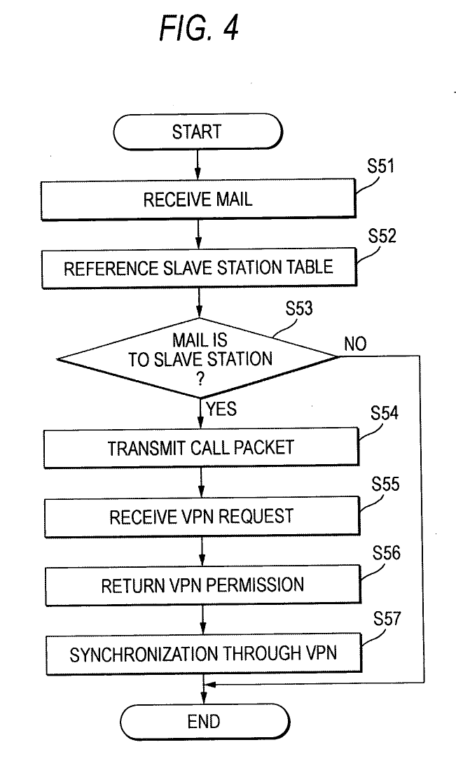

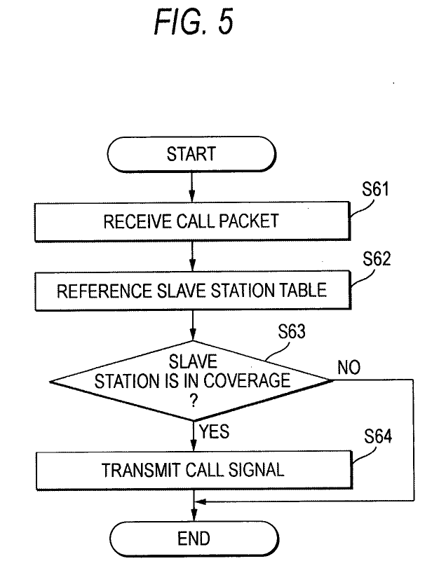

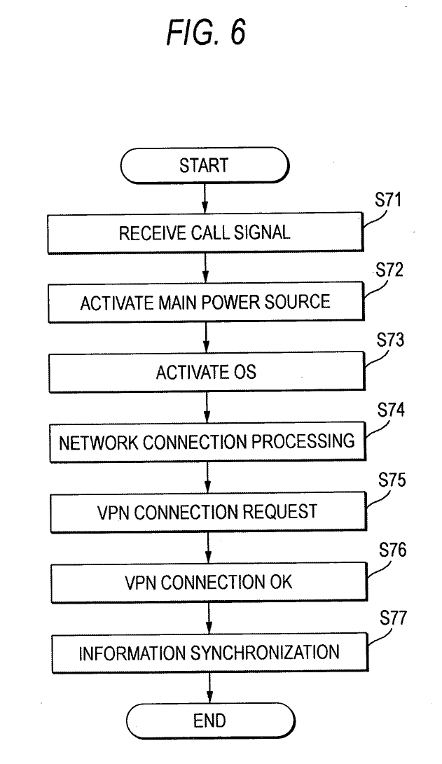

Next, operation of the communication system according to the embodiment will be described in detail referring to FIGS. 3 to 6. FIG. 4 is an exemplary flowchart showing the operation of a host server according to the embodiment. FIG. 5 is an exemplary flowchart showing the operation of a base station according to the embodiment. FIG. 6 is an exemplary flowchart showing the operation of a terminal device according to the embodiment.

Referring to FIGS. 3 and 4, operation of the host server 10 will be described. When the host server 10 receives a mail through the network 20, the I/F part 11 and the network control part 12, the information server 13 stores the received mail into a predetermined storage (S51).

After storing the mail, the information server 13 references the header of the stored mail and search a slave station table 14 to determine whether the slave station table 14 includes the destination of the received mail (S52).

When it is determined that the destination of the received mail is not included in the slave station table 14 as a result of the search (No in S53), it is determined that the terminal device does not make an access through a wireless channel and the processing is terminated.

When it is determined that the destination of the received mail is included in the slave station table 14 as a result of the search (Yes in S53), the information server 13 reads the slave station information corresponding to the destination from the slave station table 14, and generates a call packet (call frame) to call up the slave station. When the call packet is generated, the network control part 12 transmits the call packet to the network 20 through the I/F part 11 (S54).

When the host server 10 receives the VPN connection request transmitted by the terminal device 40 in response to the call packet (S55), the network control part 12 checks whether the requesting terminal device 40 is included in a regular party. When the terminal device 40 is included in the regular party, the network control part 12 returns VPN connection permission to establish a VPN connection (S56). When the terminal device 40 is not included in the regular party, the network control part 12 ignores the VPN connection request.

When a VPN connection is established and a mail synchronization request is received from the terminal device 40, the information server 13 transmits the received new mail to the terminal device 40 and performs synchronization. These communications are made through VPN.

In this way, the host server 10 according to the embodiment calls up the terminal device 40 corresponding to the destination when information such as a mail arrives. It is thus possible to transfer a new mail to the terminal device 40 even when the terminal device 40 is in the sleep mode. The host server 10 according to the embodiment establishes a VPN connection prior to synchronization of information thus assuring the security of the information to be synchronized.

Next, operation of the base station 30 will be described referring to FIGS. 3 and 5. The call packet coming from the host server 10 is transmitted to the master station server 34 through the I/F part 32 and the network control part 33 (S61). When the master station server 34 receives the call packet, the master station server 34 reads information about the slave station to be called up from the call packet and passes the information to the slave station management part 35.

When the slave station management part 35 receives the slave station information, the slave station management part 35 checks whether the slave station is in the coverage from the slave station table (not shown) (S62).

When the slave station is not in the coverage as a result of checkup (No in S63), the slave station management part 35 terminates the processing. An error message may be returned to the host server 10.

When the slave station is in the coverage as a result of checkup (Yes in S63), the slave station management part 35 instructs the RF part 36 to transmit a call signal. The call signal may be at the physical layer level specific to a wireless channel such as a call signal in the 3G system or a common pilot signal.

When the RF part 35 receives the instruction, the RF part 36 transmits the call signal for the slave station from the antenna 31 (S64).

In this way, receiving a call packet at the network layer level, the base station 30 according to the embodiment converts the packet to a call signal at the physical layer level and calls up a slave station. This approach minimizes the number of features to be implemented in the radio module of the terminal device 40 as a slave station.

Next, operation of the terminal device 40 will be described referring to FIGS. 3 and 6. The call signal transmitted from the base station 30 is passed to the RF part 42 through the antenna 41. Power is constantly supplied to the RF part 42 irrespective of the ON/OFF of the main power of the terminal device 40. The RF part 42 receives the call signal to the terminal device 40 from the antenna 41 and passes the call signal to the activation control part 43 (S71).

When the activation control part 43 receives the call signal to itself, the activation control part 43 instructs the power control part 44 to turn on the main power of the terminal device 40 to activate the terminal device 40. Receiving the instruction, the power control part 44 turns on the main power of the terminal device 40 (S72).

When the main power is supplied, the OS part 45 activates a unit or software of the terminal device 40 (S73). In particular, the OS part 45 activates the network control part 46 and then the synchronization control part 47 and the information management part 48.

When activated, the network control part 46 connects to the base station 30 through the network 20 (S74).

When a connection with the network 20 is established, the network control part 46 transmits a VPN connection request to the host server 10 through the OS part 45 and the RF part 42 (S75). VPN connection permission from the host server 10 is passed from the RF part 42 to the network control part 46 through the OS part 45 (S76).

When a VPN connection is permitted and established, the synchronization control part 47 performs synchronization of information stored in the information server 13 of the host server 10 with information stored in the information management part 48 (S77). The information management part 48 may directly access the information server 13 through the OS part 45 and the RF part 42 to download information.

In this way, the main power of the terminal device 40 according to the embodiment turns on based on the call signal specific to a wireless channel, that is, at the physical layer level. This reduces the implementation load on a radio module. It is also possible to reduce the number of features of the radio module so that power consumption is reduced. The terminal device 40 according to the embodiment is automatically activated with a call signal and then activates a security application such as VPN and synchronizes information so that secure communication is performed. Automatic activation of the terminal device 40 and network control by TCP/IP are made on separate layers so that a general VPN application can be used directly.

This invention is not limited to the above embodiment. While the 3G system is used as a wireless channel in the embodiment, the invention is not limited thereto. For example, a PHS system may be equally applied that has a specific control signal independent of the network layer where a host server and a terminal device communicate with each other.

Software that serves as the OS part, the network control part, and the synchronization control part in the above embodiment may be stored in a computer-readable storage medium such as a flexible disk or may be transmitted as separate software (or program). In this case, the software (or program) stored in a storage medium is read by a computer or such software is downloaded from a site (server) on a LAN or the Internet and installed into a computer, which makes it possible to perform processing in each embodiment.

The software (or program) in the invention is not necessarily stored in a storage medium separate from a computer but may be distributed through a transmission medium such as a LAN or the Internet.

The storage medium may be a flexible disk, a magnetic disk, an optical disc (CD-ROM, CD-R or DVD), a magneto-optical disk (MO), or a computer-readable semiconductor memory that can store a program.

An OS (Operating System) or MW (Middleware) such as database management software and network software running on a computer based on an instruction by a program installed in the computer from a storage medium may execute part of each process to implement this embodiment.

The storage medium is not limited to a medium independent of a computer but may be a storage medium in which a program on a LAN or Internet site is downloaded and stored or temporarily stored. Further, more than one medium may be used. Processing according to the embodiment may be performed from multiple media and any medium configuration is within the scope of the invention.

The computer is intended to execute each process in this embodiment based on a program stored in a storage medium. Any computer configuration such as a single unit of PC or a system of multiple networked units may be used.

The computer is not limited to a PC but may be an arithmetic operation device included in the information processing apparatus and a microcomputer, and refers to any device or apparatus capable of implementing the features of the invention by way of a program.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A terminal device comprising:
a wireless communication unit that communicates with a base station through a first communication channel;
a network controller that communicates with a computer via the base station through a second communication channel; and
a power controller that starts a power supply to the network controller in response to a call signal received by the wireless communication unit from the base station through the first communication channel.

2. The terminal device according to claim 1,
wherein the network controller transmits a VPN connection request to the computer when the power supply to the network controller starts.

3. The terminal device according to claim 1,
wherein the wireless communication unit communicates with the base station in accordance with a CDMA system.

4. The terminal device according to claim 1,
wherein the first communication channel is established at a physical layer of OSI reference model.

5. The terminal device according to claim 1,
wherein the second communication channel is established at a network layer of OSI reference model or above.

6. The terminal device according to claim 1,
wherein the power controller stops the power supply to the network controller when the terminal device is in a sleep mode.

7. A communication system comprising:
a computer;
a base station; and
a terminal device that communicates with the computer via the base station,
wherein the computer includes:
a network communication unit that communicates with the terminal device using a packet, and
a first calling unit that transmits to the base station a call packet to call the terminal device,
wherein the base station includes a second calling unit that transmits a call signal to call the terminal device in response to the call packet transmitted from the first calling unit, and
wherein the terminal device includes:
a wireless receiver that receives the call signal transmitted from the calling unit;
a network controller that communicates with the computer via the base station using the packet; and
a power controller that starts a power supply to the network controller in response to the call signal received by the wireless receiver.

8. A method for activating a terminal device including a network controller that communicates with a computer via a base station, the method comprising:
receiving a call signal transmitted from the base station through a first communication channel;
starting a power supply to the network controller in response to the call signal received at the receiving step; and
starting to communicate with the computer via the base station through a second communication channel.
